(19) United States
(12) Patent Application Publication
(10) Pub. No.: US 2009/0002314 A1
(43) Pub. Date: Jan. 1, 2009

(54) Tactile sense presentation device and tactile sense presentation method

(75) Inventor: Takuya Uchiyama, Shinagawa (JP)

Correspondence Address: STAAS & HALSEY LLP, SUITE 700, 1201 NEW YORK AVENUE, N.W., WASHINGTON, DC, 20005, US

(73) Assignee: FUJITSU COMPONENT LIMITED, Shinagawa (JP)

(21) Appl. No.: 11/907,948

(22) Filed: Oct. 18, 2007

(30) Foreign Application Priority Data
Jun. 29, 2007 (JP) 2007-172265

(51) Int. Cl. G09G 5/00

(52) U.S. Cl. 345/156

(57) ABSTRACT

A tactile sense presentation device is disclosed that drives a tactile sense unit to present a tactile sense to an operator. The device includes a location detection unit that detects the location of the tactile sense unit and a drive unit that drives the tactile sense unit with a thrust in accordance with the location detected by the location detection unit. The device controls the direction and the size of the thrust applied to the tactile sense unit in accordance with the location of the tactile sense unit detected by the location detection unit.

### BACKGROUND OF THE INVENTION

1. Field of the Invention

The present invention relates generally to tactile sense presentation devices and tactile sense presentation methods and, in particular, to a tactile sense presentation device that presents a thrust to an operator in accordance with the operating location of a tactile sense unit and a tactile sense presentation method.

2. Description of the Related Art

In recent years and continuing to the present, automobiles have various equipment items installed therein. The equipment items installed in the automobiles have their own operating devices. Accordingly, drivers must change the operating device for every equipment item they want to operate.

For example, they must operate an air conditioner operating switch to operate an air conditioner and operate an audio system operating switch to operate an audio system. Although the air conditioner operating switch and the audio system operating switch are disposed in one place, they are different operating switches. Therefore, in order to operate the operating switches while driving the automobile, the drivers must grope for the operating switches to perform required operations and gropingly operate them.

Meanwhile, various types of in-car input devices have been developed to improve operability for drivers (see, e.g., Patent Documents 1 through 4). Some of the in-car input devices transmit vibrations in response to an operation, making visual recognition by drivers unnecessary. However, they only allow the drivers to recognize the completion of the operation through the vibrations.

Furthermore, as input devices for informing operators of an operating state, there have been developed various input devices that transmit a sense of force to a joystick, a mouse, or the like to improve their operability. (see, e.g., Patent Documents 5 through 7).

Patent Document 1: JP-A-11-278173

Patent Document 2: JP-A-2000-149721

Patent Document 3: JP-A-2004-279095

Patent Document 4: JP-A-2005-96515

Patent Document 5: JP-A-2006-268154

Patent Document 6: JP-A-2005-250983

Patent Document 7: JP-A-06-202801

### SUMMARY OF THE INVENTION

However, typical input devices for transmitting a sense of force only control centripetal force of a joystick in accordance with the operating location of the pointer on a screen and transmit vibrations to a mouse.

The present invention has been made in view of the above points and may provide a tactile sense presentation device that presents a thrust to a tactile sense unit in accordance with the location of the tactile sense unit to improve operability and a tactile sense presentation method.

The present invention provides a tactile sense presentation device that drives a tactile sense unit to present a tactile sense to an operator. The device comprises a location detection unit that detects the location of the tactile sense unit; a drive unit that drives the tactile sense unit with a thrust in accordance with the location detected by the location detection unit; and a control unit that controls the direction and the size of the thrust applied to the tactile sense unit in accordance with the location of the tactile sense unit detected by the location detection unit.

According to this configuration, the control unit sets a target location in accordance with an operations area and controls the drive unit to make a thrust be applied in a direction toward the target location.

According to this configuration, the control unit sets a plurality of the target locations in accordance with the operations area and changes the target locations from one to another in accordance with the location of the tactile sense unit.

According to this configuration, the control unit restores the target location to an initial location after a predetermined time has elapsed since the change of the target location.

According to this configuration, the control unit sets the target location outside an operations range in accordance with the location of the tactile sense unit.

According to this configuration, the control unit changes the target location in accordance with time, and the control unit limits the thrust.

According to this configuration, the control unit has plural of the operations areas, sets a target location for each of the operations areas, and limits the operations area allowing for a movement of the tactile sense unit for each of the operations areas.

According to this configuration, when the tactile sense unit moves from one operations area to another operations area, the control unit changes the target location from the target location set in the one operations area to that set in the other operations area at a boundary between the one operations area and the other operations area if the other operations area is the operations area allowing for the movement of the tactile sense unit, and the control unit does not change the target location if the other operations area is the operations area not allowing for the movement of the tactile sense unit.

According to the embodiment of the present invention, the direction and the size of a thrust applied to the tactile sense unit is controlled in accordance with the position of the tactile sense unit, to thereby make it possible to inform the tactile sense unit of the boundary with the operations area through tactile sense.

### BRIEF DESCRIPTION OF THE DRAWINGS

FIG. 1 is a system block diagram of an embodiment of the present invention;

FIG. 2 is a perspective view of a tactile sense presentation device 111;

FIG. 3 is an exploded perspective view of the tactile sense presentation device 111;

FIG. 4 is a block diagram of an embodiment of the present invention at a main part;

FIG. 5 is an operations explanatory drawing of the tactile sense presentation device 111;

FIG. 6 is a processing flowchart of a tactile sense presentation system 100;

FIG. 7 is a flowchart of target location designation processing of a host computer 112;

FIG. 8 is an operations explanatory drawing of the tactile sense presentation system 100;

FIGS. 9A and 9B are operations explanatory drawings showing an example of a driving method for an operations unit 122;

FIGS. 10A and 10B are operations explanatory drawings of a first operating state of a first modified embodiment of the driving method for the operations unit 122;

FIGS. 11A and 11B are operations explanatory drawings of a second operating state of the first modified embodiment of the driving method for the operations unit 122;

FIGS. 12A and 12B are operations explanatory drawings of a second modified embodiment of the driving method for the operations unit 122;

FIGS. 13A and 13B are operations explanatory drawings of a third modified embodiment of the driving method for the operations unit 122;

FIGS. 14A and 14B are operations explanatory drawings of a fourth modified embodiment of the driving method for the operations unit 122;

FIGS. 15A and 15B are operations explanatory drawings of the fourth modified embodiment of the driving method for the operations unit 122;

FIGS. 16A and 16B are operations explanatory drawings of a fifth modified embodiment of the driving method for the operations unit 122;

FIGS. 17A and 17B are operations explanatory drawings of the fifth modified embodiment of the driving method for the operations unit 122;

FIGS. 18A and 18B are operations explanatory drawings of the fifth modified embodiment of the driving method for the operations unit 122; and

FIG. 19 is an operations explanatory drawing of the fifth modified embodiment of the driving method for the operations unit 122.

### DETAILED DESCRIPTION OF THE PREFERRED EMBODIMENT

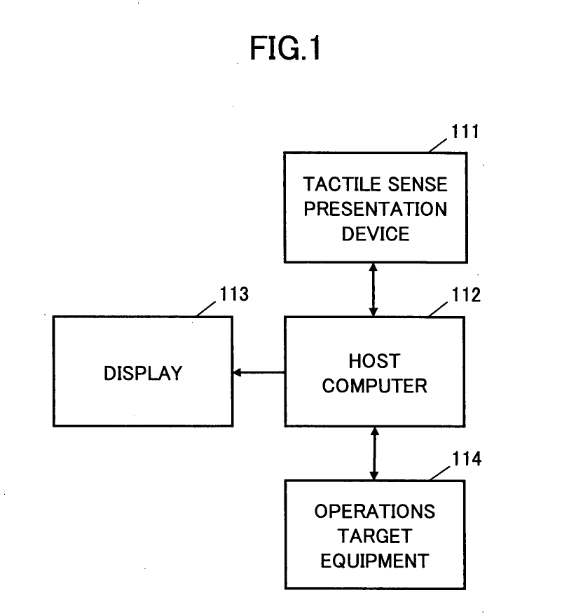

FIG. 1 is a system block diagram of an embodiment of the present invention.

A tactile sense presentation system 100 of the present embodiment is a system that is installed in an automobile or the like, issues commands to operations target equipment 114, such as an air conditioner, an audio system, and a car navigation system, and controls the same. The tactile sense presentation system 100 is composed of a tactile sense presentation device 111 that issues instructions to the operations target equipment 114, a host computer 112, and a display 113.

First, a description is made of the tactile sense presentation device 111.

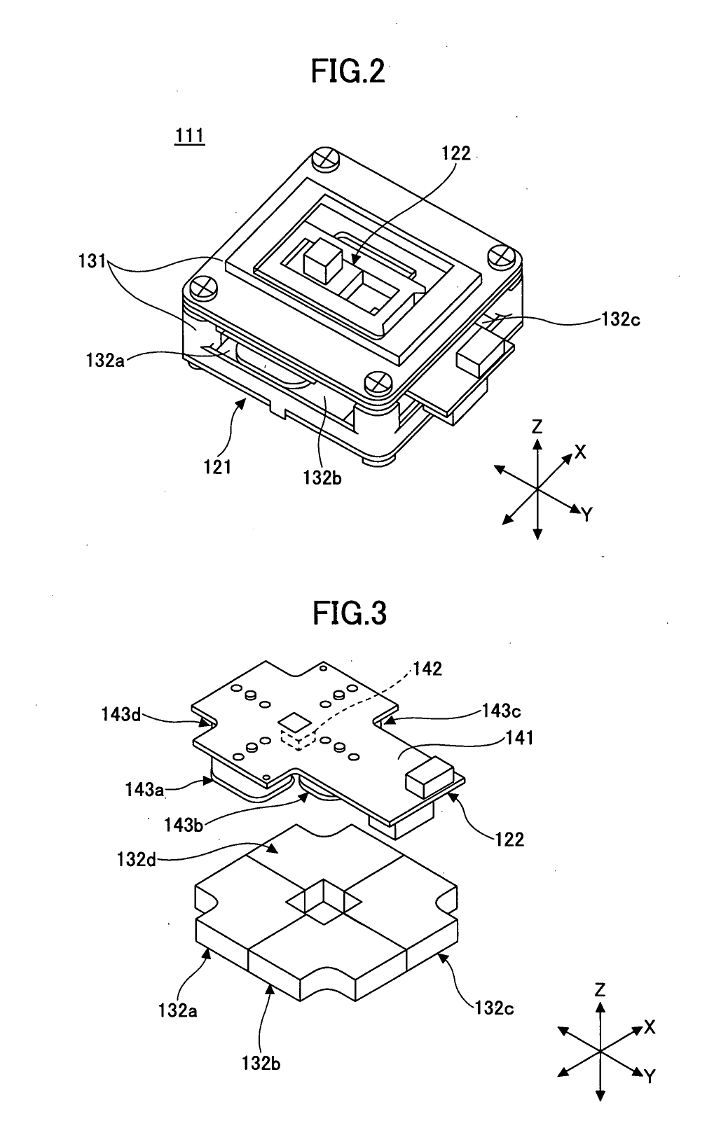

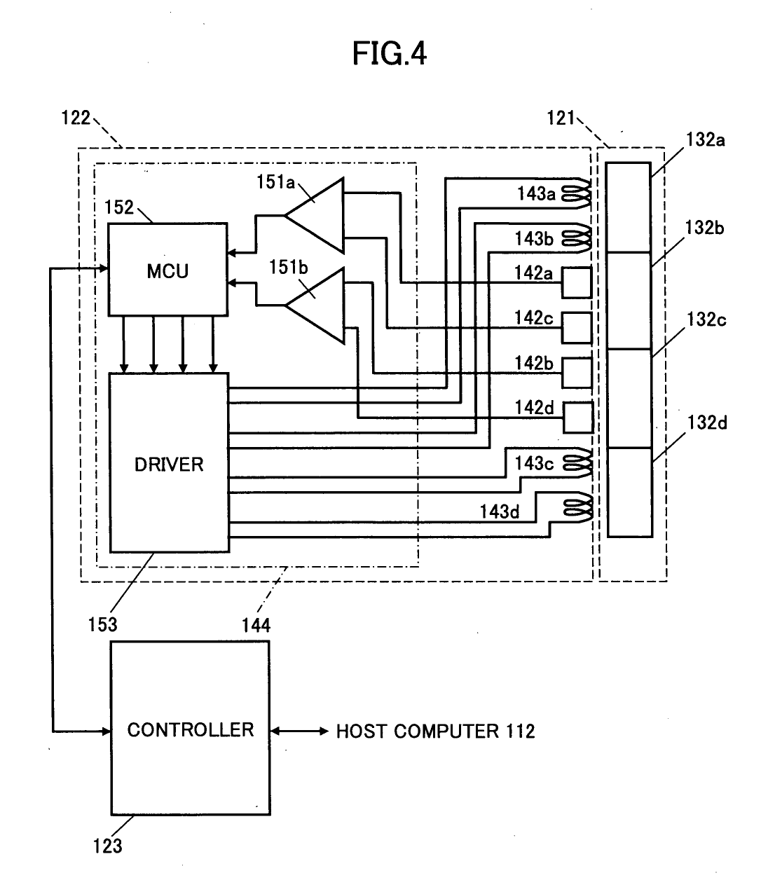

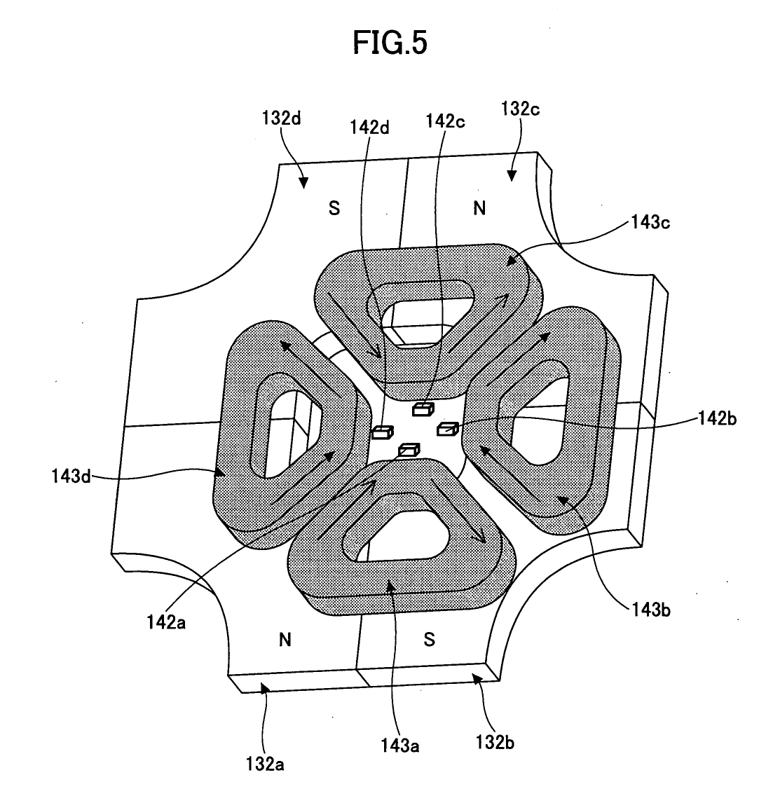

FIGS. 2 through 5 are a perspective view of the tactile sense presentation device 111, an exploded perspective view thereof, a block diagram of an embodiment of the present invention at a main part, and an operations explanatory drawing of the tactile sense presentation device 111, respectively.

The tactile sense presentation device 111 is a so-called tactile sense actuator and composed of a fixed unit 121, an operations unit 122, and a controller 123. The tactile sense presentation device 111 is fixed, for example, to the steering of a vehicle. The tactile sense presentation device 111 is a device that outputs to the host computer 112 the location information of the operations unit 122 relative to the fixed unit 121 and drives the operations unit 122 on an X-Y plane in accordance with the drive information from the host computer 112.

The fixed unit 121 is configured so that magnets 132a, 132b, 132c, and 132d are substantially annularly fixed to a frame 131 on the X-Y plane. The magnets 132a, 132b, 132c, and 132d are shaped like a plate and have a magnetic pole in a direction orthogonal to the X-Y plane, i.e., the Z direction as indicated by an arrow. Furthermore, the adjacent magnets are arranged so as to make their polarities different from one another.

The operations unit 122 is configured to have a circuit substrate 141 on which a hole IC 142, coils 143a, 143b, 143c, and 143d, and a drive circuit 144 are mounted.

The hole IC 142 has four hole elements 142a, 142b, 142c, and 142d mounted thereon. The hole elements 142a, 142b, 142c, and 142d are connected to the drive circuit 144.

The drive circuit 144 is composed of amplifiers 151a and 151b, a MCU 152, and a driver IC 153. The amplifier 151a outputs a difference between the output of the hole element 142a and that of the hole element 142c. The hole elements 142a and 142c are arranged, for example, in the X-axis direction. The output of the amplifier 151a becomes a signal corresponding to the location of the operations unit 122 in the X-axis direction relative to the fixed unit 121.

The amplifier 151b outputs a difference between the output of the hole element 142b and that of the hole element 142d. The hole elements 142b and 142d are arranged, for example, in the Y-axis direction. The output of the amplifier 151b becomes a signal corresponding to the location of the operations unit 122 in the Y-axis direction relative to the fixed unit 121.

The outputs of the amplifiers 151a and 151b are supplied to the MCU 152. The MCU 152 generates the location information of the operations unit 122 relative to the fixed unit 121 based on the outputs of the amplifiers 151a and 151b and supplies the generated location information to the host computer 112.

Furthermore, the MCU 152 supplies a drive signal to the driver IC 153 based on the drive instructions supplied from the host computer 112.

The driver IC 153 supplies a drive current to the coils 143a, 143b, 143c, and 143d based on the drive signal from the MCU 152. The coils 143a, 143b, 143c, and 143d are arranged opposite to the magnets 132a, 132b, 133c, and 133d, respectively. The coils 143a, 143b, 143c, and 143d are arranged so as to be laid across the magnets 132a and 132b, the magnets 132b and 132c, the magnets 132c and 132d, and the magnets 132d and 132a, respectively. The above configuration constitutes a voice coil motor that is driven parallel to the X-Y plane by the magnets 132a, 132b, 132c, and 132d and the coils 143a, 143b, 143c, and 143d.

Accordingly, the operations unit 122 moves in parallel on the X-Y plane as the drive current is fed to the coils 143a, 143b, 143c, and 143d.

The host computer 112 controls the display of the display 113 and the movement of the operations target equipment 114 based on the location information from the tactile sense presentation device 111. Furthermore, the host computer 112 generates drive instructions for driving the operations unit 122 based on the information from the operation target equipment 114 and supplies the generated drive instructions to the tactile sense presentation device 111. The tactile sense presentation device 111 drives the operations unit 122 based on the drive instructions from the host computer 112.

Next, a description is made of the host computer 112.

The host computer 112 is composed of a microcomputer. The host computer 112 is capable of communicating with the operations target equipment 114, such as an air conditioner, an audio system, and a car navigation system, via a prescribed interface and of integrally controlling them. Furthermore, the host computer 112 displays on the display 113 an operations screen for an air conditioner, an audio system, and a car navigation system, a status screen for showing a system status, and the like. At this time, the host computer 112 controls the operations target equipment 114, such as an air conditioner, an audio system, and a car navigation system, according to the operations information of the tactile sense presentation device 111 supplied from the controller 123.

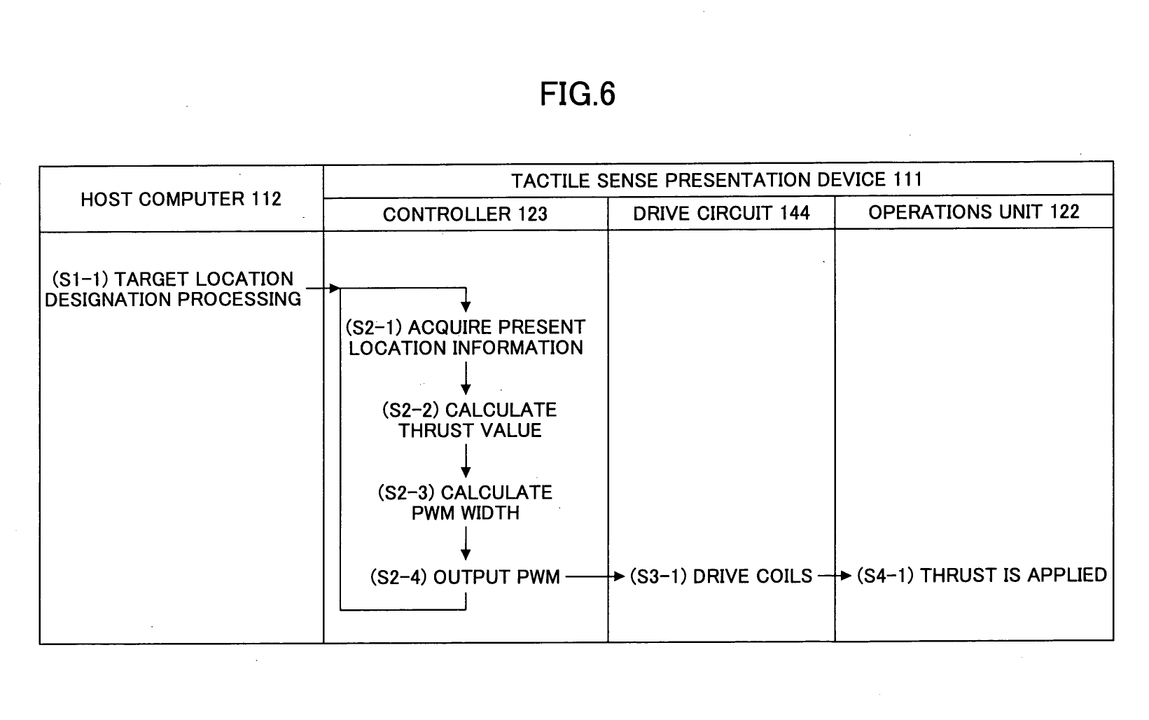

FIG. 6 is a processing flowchart of the tactile sense presentation system 100.

The host computer 112 executes target location designation processing and generates a target location designation command in step S1-1. The host computer 112 supplies the generated target location designation command to the controller 123.

Upon receipt of the target location designation command from the host computer 112, the controller 123 acquires from the drive circuit 144 present location information of the operations unit 122 relative to the fixed unit 121 in step S2-1.

The controller 123 calculates a thrust value based on a difference between the present location and the target location in step S2-2. The calculation of a thrust value is based on an automatic control system such as PID (Proportional Integral Differential) control. A thrust value to make the present location be smoothly shifted to the target location is calculated. For example, if the present location is away from the target location, a thrust value to apply a large thrust directed in the target direction is generated. While if the present location is near the target location, a thrust value to apply a small thrust is generated.

The controller 123 calculates the pulse width of a drive pulse, PWM width, which is to be supplied to the coils 143a, 143b, 143c, and 143d, from the thrust value in step S2-3 and outputs the drive pulse to drive circuit 144 in step S2-4.

Upon receipt of the drive pulse from the controller 123, the drive circuit 144 supplies a current corresponding to the drive pulse to the coils 143a, 143b, 143c, and 143d in step S3-1. The magnetic fields generated in the coils 143a, 143b, 143c, and 143d and those generated in the magnets 132a, 132b, 132c, and 132d are caused to act together to apply a thrust to the operations unit 122 in step S4-1.

In the above manner, a thrust is applied to the operations unit 122.

Next, a description is made of the target location designation processing executed by the host computer 112.

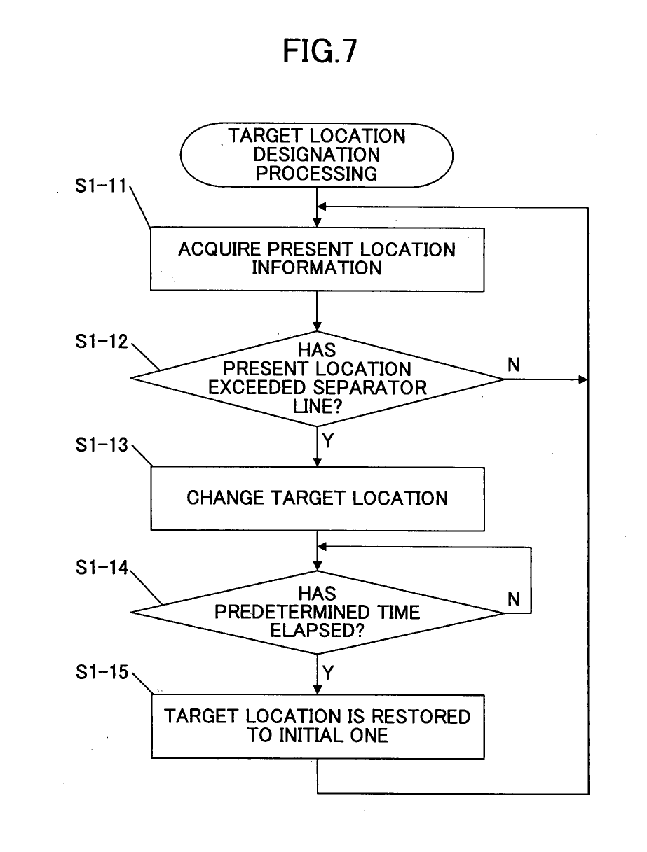

FIG. 7 is a flowchart of the target location designation processing of the host computer 112.

The host computer 112 first acquires the present location information of the operations unit 122 from the controller 123 in step S1-11. The host computer 112 determines, in step S1-12, whether the present location of the operations unit 122, i.e., the pointer on the operations screen displayed on the display 113 has exceeded the imaginary separator line previously set on the operations screen.

If the present location has exceeded the separator line in step S1-12, the host computer 112 changes, in step S1-13, the target location to the one previously set in the present area and informs the controller 123 of it. Note that the target location may be expressed in the form of dots, lines, or a constant area.

Next, the host computer 112 determines, in step S1-14, whether a predetermined time has elapsed since the change of the target location. After the elapse of the predetermined time in step S1-14, the host computer 112 restores the target location to the initial one in step S1-15 and informs the controller 123 of it. The target location before the change may also be, for example, a previously set given location as a reference.

In the above manner, the host computer 112 sets the target location for determining the direction in which a thrust is caused to be applied in accordance with the location of the operations unit 122 or the pointer on the operations screen and informs the controller 123 of it. The controller 123 performs the PID control of the location based on the target location received from the host computer 112 and the present location of the operations unit 122. Accordingly, it is possible to apply a thrust directed to the target location to the operations unit 122.

Next, a description is made of the exchange of information and the processing thereof in the tactile sense presentation system 100.

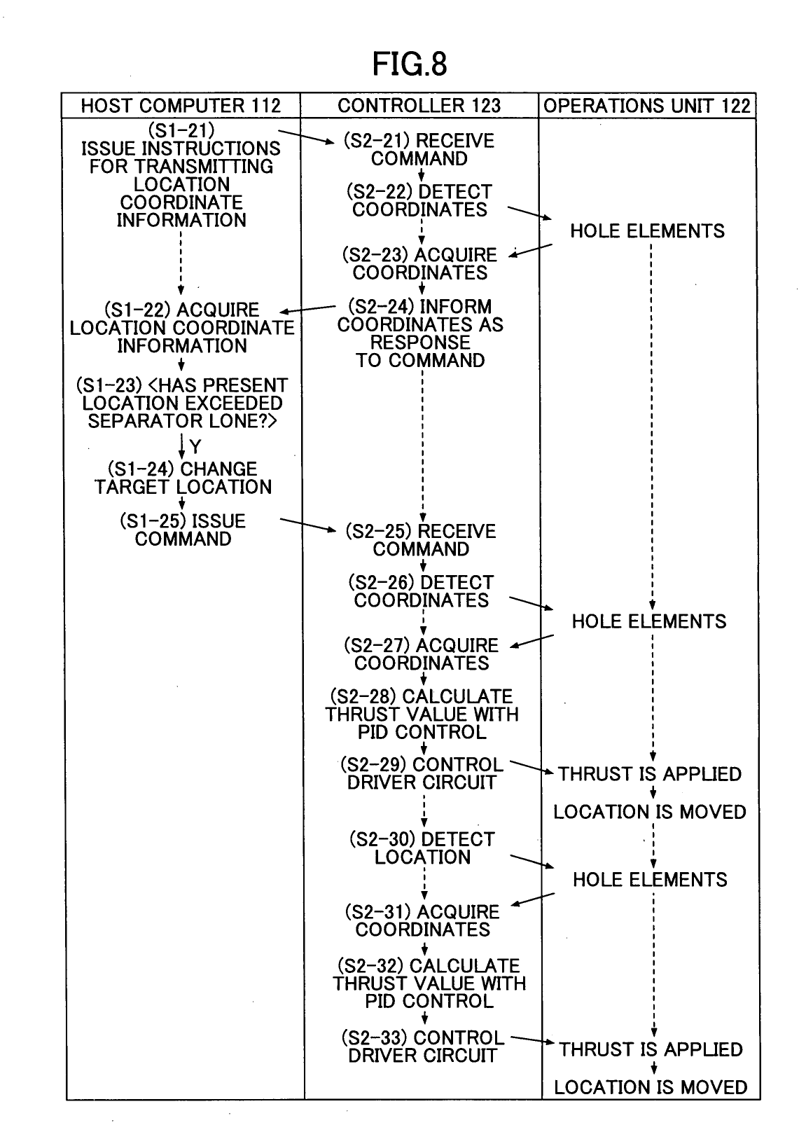

FIG. 8 is an operations explanatory drawing of the tactile sense presentation system 100.

The host computer 112 instructs the controller 123 to transmit location information coordinates in step S1-21.

Upon receipt of the command from the host computer 112 in step S2-21, the controller 123 detects a signal from the hole elements 142a, 142b, 142c, and 142d in step S2-22 and acquires the location coordinates of the operations unit 122 based on the signal detected from the hole elements 142a, 142b, 142c, and 142d in step S2-23.

The controller 123 informs the host computer 112 of the location coordinates as a response to the command in step S2-24.

Upon receipt of the location coordinates of the operations unit 122 from the controller 123 in S1-22, the host computer 112 determines, in step S1-23, whether the location of the operations unit 122 has exceeded the separator line based on the previous location coordinates and the present location coordinates. If the operations unit 122 has exceeded the separator line in step S1-23, the host computer 112 informs the controller 123 of the command containing the target location set in the area of the present location coordinates in step S1-24.

Upon receipt of the command from the host computer 112 in step S2-25, the controller 123 detects a signal again from the hole elements 142a, 142b, 142c, and 142d in step S2-26 and acquires the location coordinates of the operations unit 122 based on the signal detected from the hole elements 142a, 142b, 142c, and 142d in step S2-27.

The controller 123 calculates a thrust value with the PID control, based on the target location coordinates received from the host computer 112 and the acquired location coordinates in step S2-28. The controller 123 controls the driver circuit 144 based on the thrust value acquired from the calculation in step S2-29. Accordingly, a thrust is applied to the operations unit 122 to change the location thereof. The controller 123 detects a signal again from the hole elements 142a, 142b, 142c, and 142d in step S2-30 and acquires the location coordinates of the operations unit 122 based on the signal detected from the hole elements 142a, 142b, 142c, and 142d in step S2-31.

The controller 123 calculates a thrust value with the PID control, based on the target location coordinates received from the host computer 112 and the acquired location coordinates in step S2-32. The controller 123 controls the driver circuit 144 based on the thrust value acquired from the calculation in step S2-33.

Note that steps S2-27 through S2-33 refer to target location control by the controller 123. The target location control is an operation of acquiring the location coordinates of the operations unit 122 regardless of the instructions from the host computer 112 and accordingly changing a thrust as needed. In this embodiment, the host computer 112 acquires the location coordinates of the operations unit 122 in steps S1-21 through S1-24 and changes the target location coordinates based on the acquired location coordinates of the operations unit 122. However, if the controller 123 keeps the target location coordinates, it can change the target location coordinates based on the location coordinates of the operations unit 122 independently acquired, regardless of the instructions from the host computer 112.

Next, a description is made of a driving method for the operations unit 122.

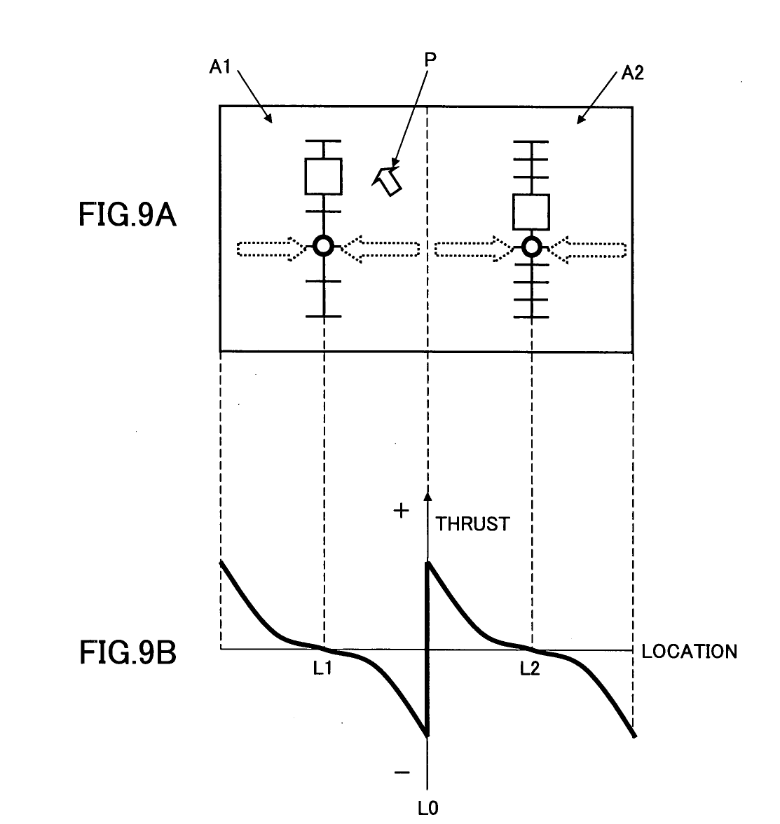

FIGS. 9A and 9B are operations explanatory drawings showing an example of the driving method for the operations unit 122. FIGS. 9A and 9B show an operations screen and the size of a thrust in accordance with the location, respectively. In FIGS. 9A and 9B, L1 and L2 indicate the target location in an operations area A1 and that in an operations area A2, respectively, and L0 indicates the separation (boundary) location between the operations areas A1 and A2.

If the pointer P exceeds the separation location L0 as shown in FIG. 9A, the controller 123 changes the target location either from L1 to L2 or from L2 to L1. Note that the pointer P is displayed on the screen at a location in accordance with the operating location of the operations unit 122.

For example, if the pointer P in the operations area A1 crosses over the separation location L0 to move into the operations area A2, the target location is changed from L1 to L2. While if the pointer P in the operations area A2 crosses over the separation location L0 to move into the operations area A1, the target location is changed from L2 to L1.

With the change of the target location, a thrust applied to the operations unit 122 is changed as shown in FIG. 9B. As shown in FIG. 9B, if the pointer P in the operations area A1 is at the target location L1, no thrust is applied to the operations unit 122. If the pointer P is away from the target location L1, a thrust directed to the target location L1 is applied. Furthermore, the thrust is increased in accordance with the distance from the target location L1.

Similarly, if the pointer P in the operations area A2 is at the target location L2, no thrust is applied to the operations unit 122. If the pointer P is away from the target location L2, a thrust directed to the target location L2 is applied. Furthermore, the thrust is increased in accordance with the distance from the target location L2.

With the above configuration, when the pointer P crosses over the separation location L0, the user feels as if a wall is around him/her while operating the operations unit 122. Accordingly, it is possible for the user to recognize the change of the operations area either from A1 to A2 or A2 to A1.

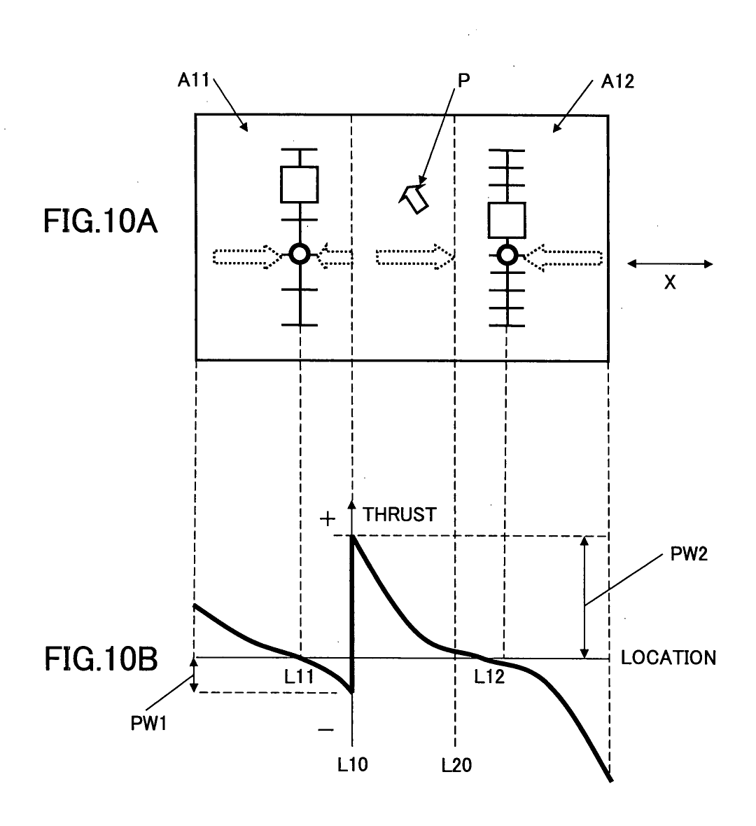

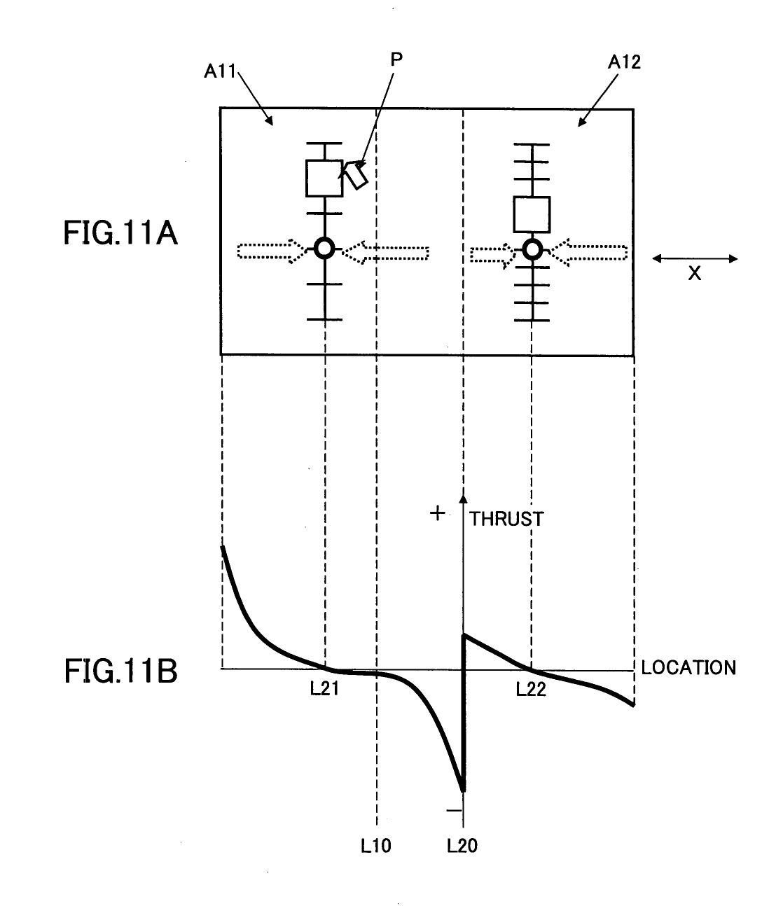

FIGS. 10A and 10B and 11A and 11B are operations explanatory drawings of a first operating state of a first modified embodiment of the driving method for the operations unit 122 and those of a second operating state thereof, respectively. FIGS. 10A and 11A and 10B and 11B show an operations screen and the size of a thrust in accordance with the location, respectively. In FIGS. 10A and 10B and 11A and 11B, L10, L11, and L12 indicate the separation location, the target location in operations area A11, and the target location in the operations area A12, respectively.

FIGS. 10A and 10B show the first operating state in which the pointer P exists in the operations area A12. In the first operating state, the target location is set at L20. Where the target location is set at L20, the length in the X direction as indicated by an arrow in the operations area A12 is set larger than that in the X direction as indicated by an arrow in the operations area A11, to thereby make it possible to easily perform the operation in the operations area A12.

Furthermore, the maximum value PW2 of a thrust in the operations area A12 is set larger than the maximum value PW1 of a thrust in the operations area A11. Accordingly, a large thrust directed to the target location L12 in the operations unit A12, where an operation is to be performed, is applied to the operations unit 122. Thus, it is possible to reliably perform the operation.

Furthermore, when the operations unit 122 is operated to move the pointer P into the the operations area A11 so as to perform the operation in the operations area A11 under the first operating state, the target location is changed from L20 to L10 to create the second operating state as shown in FIGS. 11A and 11B.

In the second operating state, the length in the X direction as indicated by an arrow in the operations area A11 is set larger than that in the X direction as indicated by an arrow in the operations area A12, to thereby make it possible to easily perform the operation in the operations area A11.

The maximum value PW1 of a thrust in the operations area A11 is set larger than the maximum value PW2 of a thrust in the operations area A12. Accordingly, a large thrust directed to the target location L21 in the operations area A11, where an operation is to be performed, is applied to the operations unit 122. Thus, it is possible to reliably perform the operation. Furthermore, it is possible to reliably recognize the change of the operations area because of a large change in thrust between the operations areas A11 and A12.

Furthermore, according to this modified embodiment, the size of a thrust applied to the target location L21 in the operations area A11 is made different from that of a thrust applied to the target location L22 in the operations area A12. Accordingly, it is possible for the user to recognize the operations areas A11 and A12 depending on the difference in thrust applied to the operations unit 122.

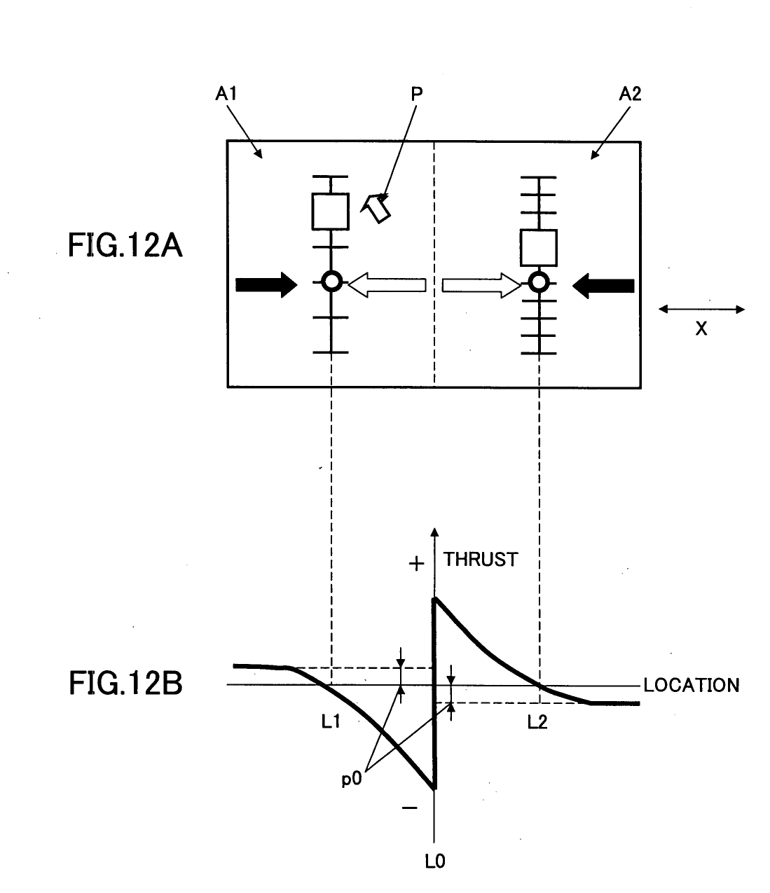

FIGS. 12A and 12B are operations explanatory drawings of a second modified embodiment of the driving method for the operations unit 122. FIGS. 12A and 12B show an operating screen and the size of a thrust in accordance with the location, respectively. Furthermore, the same components as those of FIGS. 9A and 9B are indicated by the same numerals and are not described below.

This modified embodiment is that the thrusts at both ends in the X direction as indicated by an arrow are limited to the limited value p0 in the driving method of FIGS. 9A and 9B.

According to this modified embodiment, a thrust applied to the separation location L0 between the operations areas A1 and A2 becomes large and those applied in the directions of both ends are limited to the limited value p0. Therefore, it is possible to reliably recognize the change of the operations area.

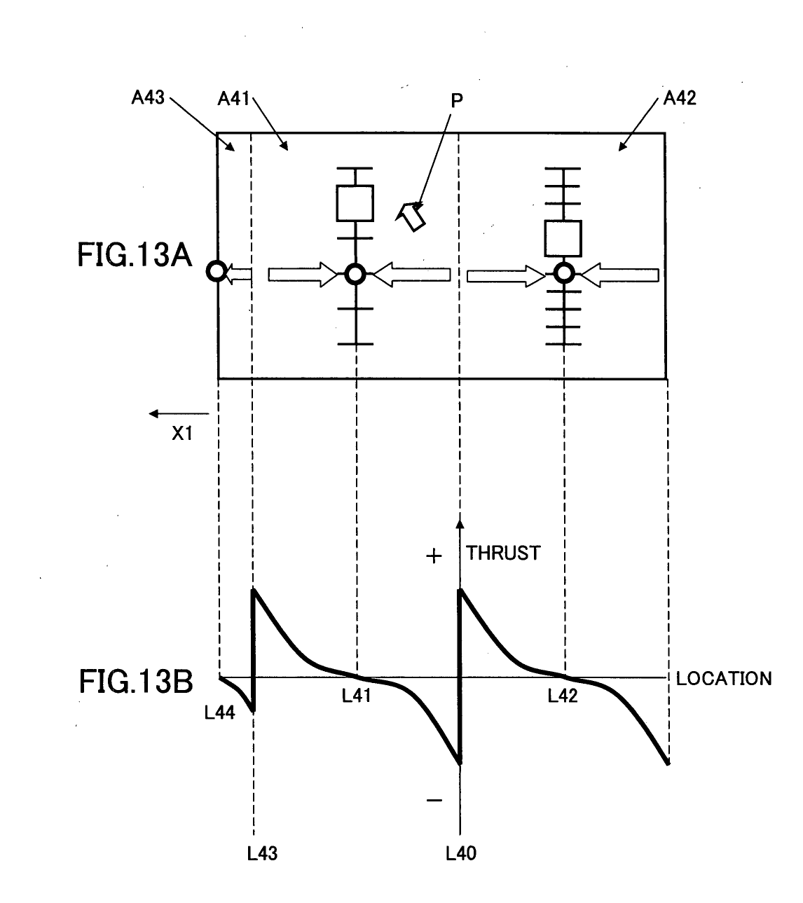

FIGS. 13A and 13B are operations explanatory drawings of a third modified embodiment of the driving method for the operations unit 122. FIGS. 13A and 13B show an operating screen and the size of a thrust in accordance with the location, respectively. In FIGS. 13A and 13B, A41 and A42 indicate operations areas; A43 indicates a screen change area; L40 indicates the separation location between the operations areas A41 and A42; L43 indicates the separation location between the operations area A41 and the screen change area A43; L41 indicates the target location in the operations area A41; L42 indicates the target location in the operations area A42; and L44 indicates the target location in the screen change area A43.

This modified embodiment is configured to arrange the screen change area A43 in the operations area A1 at its end in the X1 direction as indicated by an arrow. When the pointer P is moved into the screen change area A43, the operating screen is changed so that the operation can be performed on a different operations screen. At this time, the target location is changed to L44 in the screen change area A43. Note that the inclination of a thurst directed to the target location L44 in the screen change area A43 is set the same as those in the other areas A41 and A42. Therefore, the size of a thrust directed to the target location L44 in the screen change area A43 becomes smaller than those in the other areas A41 and A42.

For example, an operations screen for operating the volume and the balance of an audio system is changed to a screen for operating the temperature or the volume of air of an air conditioner.

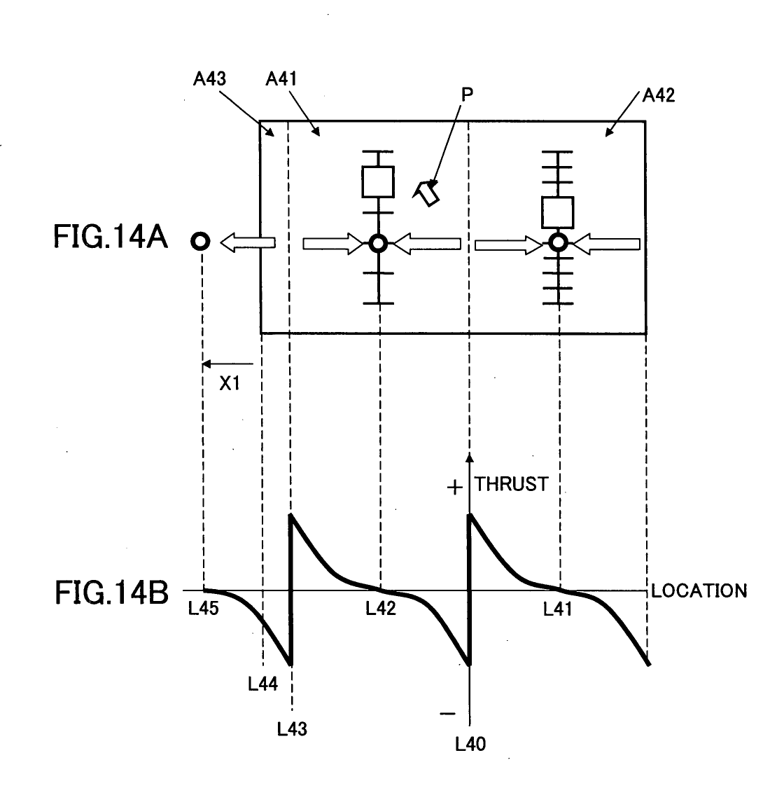

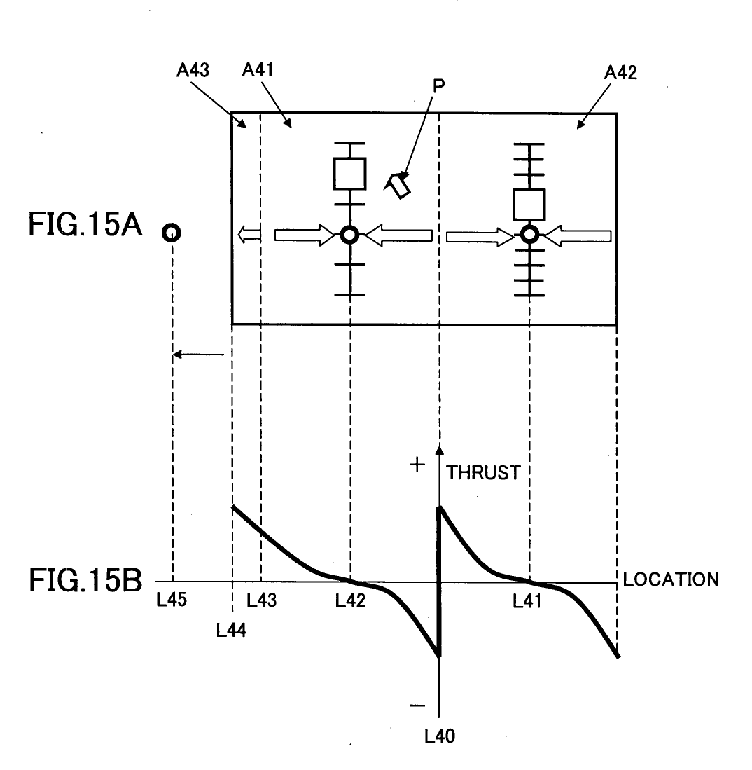

FIGS. 14A and 14B and 15A and 15B are operations explanatory drawings of a fourth modified embodiment of the driving method for the operations unit 122. FIGS. 14A and 15A and 14B and 15B show an operating screen and the size of a thrust in accordance with the location, respectively. Note that the same components as those of FIGS. 13A and 13B are indicated by the same numerals and are not described below.

In the third modified embodiment, the thrust directed to the target location L44 is small in the screen change area A43, because the inclination of a thrust waveform is constant regardless of the operations area and the length in the X direction as indicated by an arrow is small in the screen change area A43. As a result, a sufficient operational feeling cannot be obtained.

Therefore, in this modified embodiment, the target location in the screen change area A43 is set at L45. The target location L45 is an imaginary location set outside the screen change area A43. The setting of the target location at L45 can provide a suitable thrust waveform the same as those in the operations areas A41 and A42 and a thrust equivalent to those in the operations areas A41 and A42 even in the screen change area A43. Accordingly, it is possible to reliably recognize the operation of changing the screen.

Furthermore, as shown in FIGS. 15A and 15B, the target location in the screen change area A43 may be changed to the target location L42 in the operations area A41 as the initial target location after a predetermined period has elapsed. Accordingly, it is possible to automatically restore the operations unit 122 to the operations area after the change of the screen to improve the operability.

Note that the inclination of a thrust waveform in the screen change area A43 is equivalent to those in the operations areas A41 and A42. However, it may be larger than the inclination of the thrust waveform in the operations areas A41 and A42 to obtain a larger thrust even in the screen change area A43.

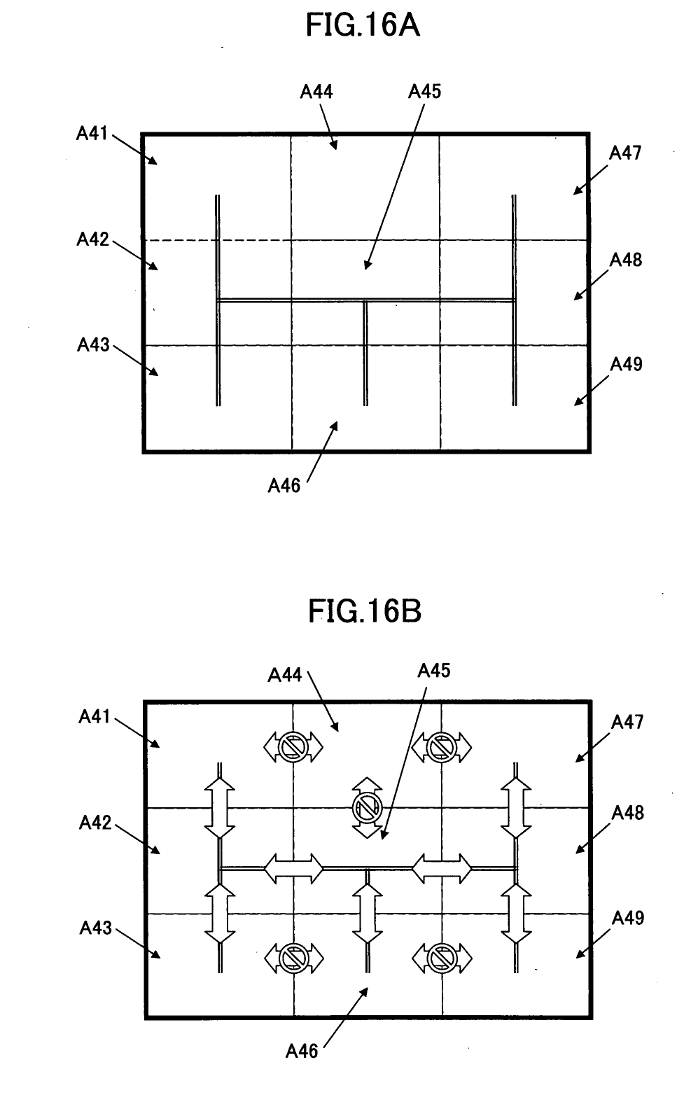

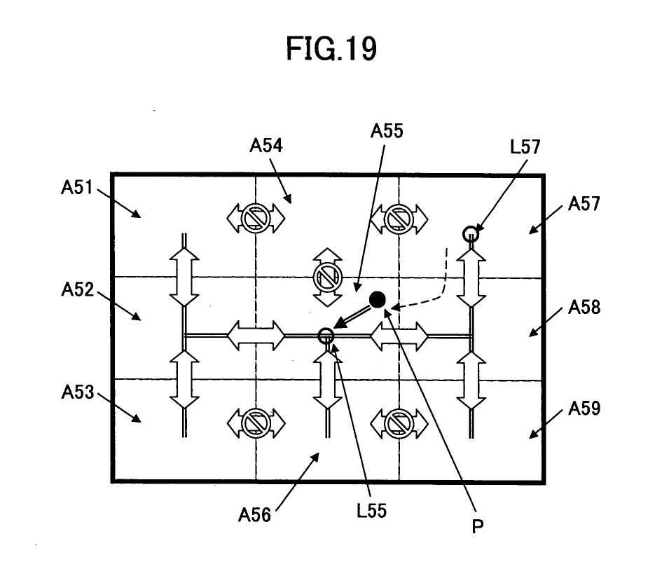

FIGS. 16A and 16B through 19 are operations explanatory drawings of a fifth modified embodiment of the driving method for the operations unit 122. FIGS. 16A and 16B show an operating screen and the size of a thrust in accordance with the location, respectively.

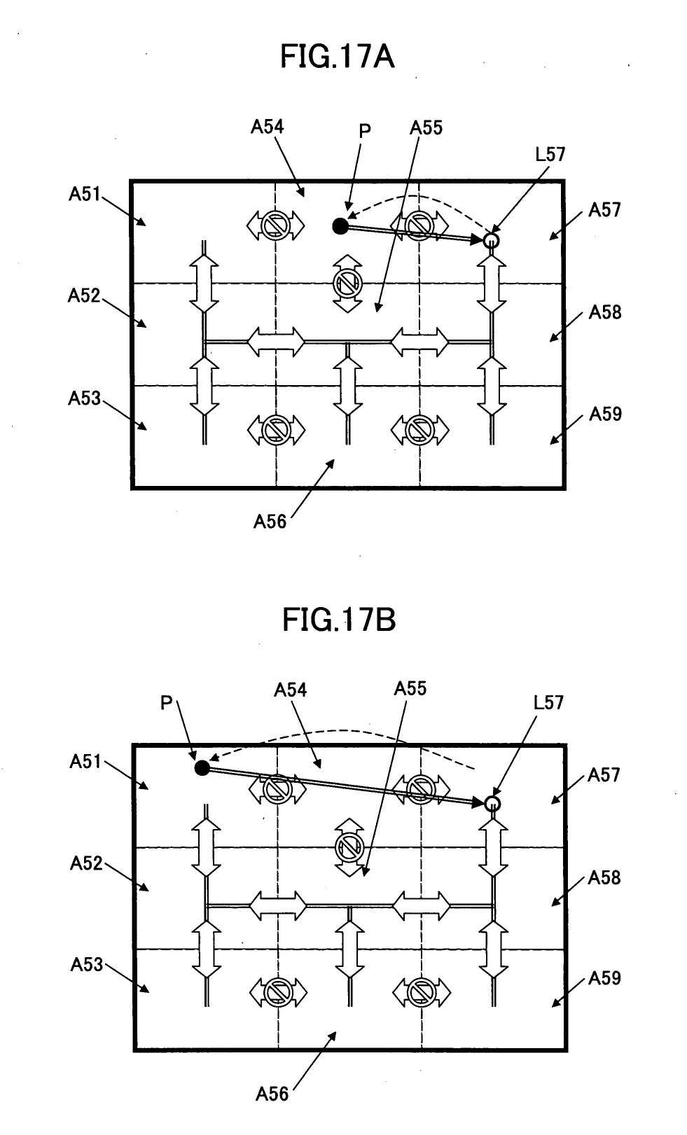

In this modified embodiment, there are a number of, e.g., nine operations areas A41 through A49. The target location here is set in accordance with the location of the pointer P so that the movement of the pointer P is limited within the operations areas. For example, the pointer P is capable of moving only within the operations areas as indicated by the double lines in FIG. 16A and the target location is changed by the movement of the pointer P as indicated by arrows in FIG. 16B.

Where the pointer P is moved from the operations area A57 to the operations area A54 as indicated by the broken lines in FIG. 17A, the movement of the pointer P from the operations area A57 to the operations area A54 is not allowed. Therefore, the target location is held at the target location L57 in the operations areas A57, and a thrust directed to the target location L57 is applied to the operations unit 122.

Furthermore, where the pointer P is moved from the operations area A57 to the operations area A51 as indicated by the broken lines in FIG. 17B, the movement of the pointer P from the operations area A57 to the operations area A51 is not allowed. Therefore, the target location is held at the target location L57 in the operations area A57, and a thrust directed to the target location L57 is applied to the operations unit 122.

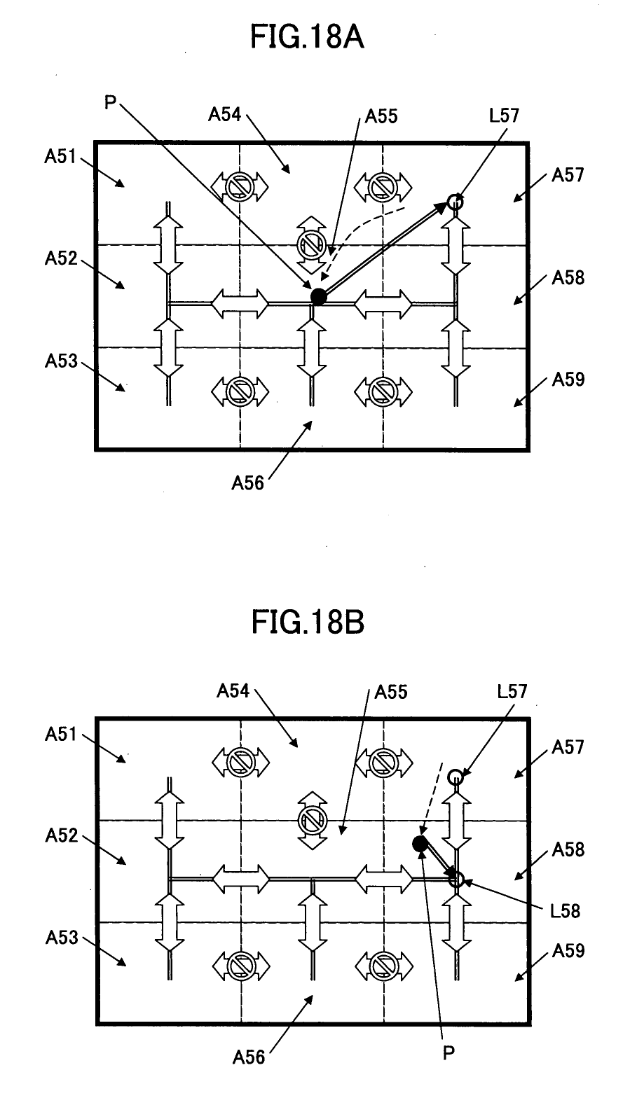

Moreover, where the pointer P is moved from the operations area A57 to the operations area A55 without passing through the operations area A58 as indicated by the broken lines in FIG. 18A, the pointer P is indirectly moved from the operations area A57 to the operations area A55. Therefore, the target location is held at the target location L57 in the operations area A57, and a thrust directed to the target location L57 is applied to the operations unit 122.

Furthermore, where the pointer P is moved from the operations area A57 to the operations area A58 as indicated by the broken lines in FIG. 18B, the movement from the operations area A57 to the operations area A58 is allowed. Therefore, the target location is moved from the target location L57 in the operations area A57 to the target location L58 of the operations area A58, and a thrust directed to the target location L58 is applied to the operations unit 122.

Moreover, where the pointer P is moved from the operations area A57, through the operations area A58, to the operations area A55, the movement from the operations area A57 to operations area A58 and that from the operations area A58 to the operations area A55 are allowed. Therefore, the target location is moved from the target location L57 in the operations area A57 to the target location L55 in the operations area A55, and a thrust directed to the target location L55 is applied to the operations unit 122.

In the above manner, the operator can be given an excellent operational feeling.

Note that the area A43 is used as the screen change area in the third and fourth modified embodiments, but it is not limited to the screen change area.

The present invention is not limited to the specifically disclosed embodiment, and variations and modifications may be made without departing from the scope of the present invention.

The present application is based on Japanese Priority Application No. 2007-172265 filed on Jun. 29, 2007, with the Japan Patent Office, the entire contents of which are hereby incorporated by reference.

What is claimed is:

1. A tactile sense presentation device that drives a tactile sense unit to present a tactile sense to an operator, comprising:
a location detection unit that detects a location of the tactile sense unit;
a drive unit that drives the tactile sense unit with a thrust in accordance with the location detected by the location detection unit; and
a control unit that controls a direction and a size of the thrust applied to the tactile sense unit in accordance with the location of the tactile sense unit detected by the location detection unit.

2. The tactile sense presentation device according to claim 1, wherein
the control unit sets a target location in accordance with an operations area and controls the drive unit to make a thrust be applied in a direction toward the target location.

3. The tactile sense presentation device according to claim 2, wherein
the control unit sets a plurality of the target locations in accordance with the operations area and changes the target locations from one to another in accordance with the location of the tactile sense unit.

4. The tactile sense presentation device according to claim 3, wherein
the control unit restores the target location to an initial location after a predetermined time has elapsed since the change of the target location.

5. The tactile sense presentation device according to claim 2, wherein
the control unit sets the target location outside an operations range in accordance with the location of the tactile sense unit.

6. The tactile sense presentation device according to claim 1, wherein
the control unit changes the target location in accordance with time.

7. The tactile sense presentation device according to claim 1, wherein
the control unit limits the thrust.

8. The tactile sense presentation device according to claim 2, wherein
the control unit has plural of the operations areas, sets a target location for each of the operations areas, and limits the operations area allowing for a movement of the tactile sense unit for each of the operations areas.

9. The tactile sense presentation device according to claim 8, wherein, when the tactile sense unit moves from one operations area to another operations area,
the control unit changes the target location from the target location set in the one operations area to that set in the other operations area at a boundary between the one operations area and the other operations area if the other operations area is the operations area allowing for the movement of the tactile sense unit, and
the control unit does not change the target location if the another operations area is the operations area not allowing for the movement of the tactile sense unit.

10. A tactile sense presentation method for a tactile sense presentation device that drives a tactile sense unit to present a tactile sense to an operator, the method comprising:
having a location detection unit that detects a location of the tactile sense unit and a drive unit that drives the tactile sense unit with a thrust in accordance with the location detected by the location detection unit; and
controlling a direction and a size of the thrust applied to the tactile sense unit in accordance with the location of the tactile sense unit detected by the location detection unit.

11. The tactile sense presentation method according to claim 10, further comprising the steps of:
setting a target location in accordance with an operations area; and
controlling the drive unit to make a thrust be applied in a direction toward the target location.

12. The tactile sense presentation method according to claim 11, further comprising the steps of:
setting a plurality of the target locations in accordance with the operations area; and
changing the target locations from one to another in accordance with the location of the tactile sense unit.

13. The tactile sense presentation method according to claim 12, further comprising the step of:
restoring the target location to an initial location after a predetermined time has elapsed since the change of the target location.

14. The tactile sense presentation method according to claim 11, further comprising the step of
setting the target location outside an operations range in accordance with the location of the tactile sense unit.

15. The tactile sense presentation method according to claim 10, further comprising the step of:
changing the target location in accordance with time.

16. The tactile sense presentation method according to claim 10, further comprising the step of:
limiting the thrust.

17. The tactile sense presentation method according to claim 11, further comprising the steps of:
having plural of the operations areas;
setting a target location for each of the operations areas; and
limiting the operations area allowing for a movement of the tactile sense unit for each of the operations areas.

18. The tactile sense presentation method according to claim 17, comprising the steps of, when the tactile sense unit moves from one operations area to another operations area,
changing the target location from the target location set in the one operations area to that set in the other operations area at a boundary between the one operations area and the other operations area if the other operations area is the operations area allowing for the movement of the tactile sense unit; and
not changing the target location if the other operations area is the operations area not allowing for the movement of the tactile sense unit.
